(19) United States
(12) Patent Application Publication
(10) Pub. No.: US 2009/0155633 A1
(43) Pub. Date: Jun. 18, 2009

(54) Fuel Cell Hybrid Power Supply Apparatus

(75) Inventors: Ming-Yao Dong, ChuPei City (TW); Wen-Hsing Chang, ChuPei City (TW)

Correspondence Address: NIKOLAI & MERSEREAU, P.A., 900 SECOND AVENUE SOUTH, SUITE 820, MINNEAPOLIS, MN, 55402, US

(73) Assignee: SYSPOTEK CORPORATION, ChuPei City (TW)

(21) Appl. No.: 12/328,533

(22) Filed: Dec. 4, 2008

(30) Foreign Application Priority Data
Dec. 17, 2007 (TW) 096148186

(51) Int. Cl. H01M 12/02

(52) U.S. Cl. 429/9

(57) ABSTRACT

A fuel cell hybrid power supply apparatus comprises a fuel cell power supply circuit and a secondary battery power supply circuit. Wherein a charger unit of the secondary battery power supply circuit determines the power characteristics for the recharging of a secondary battery unit of the secondary battery power supply circuit, based on the electrical signal outputted by a sensor unit of the fuel cell power supply circuit; the sensor unit regulates the predetermined voltage levels separately at output terminal of the fuel cell power supply circuit and the secondary battery power supply circuit with a differential between said voltage levels based on the power transmitted by the fuel cell power supply circuit, and controls the recharging of the secondary battery unit by the charger unit; and a fuel cell unit of the fuel cell power supply circuit outputs power at a predetermined constant work rate.

### FIELD OF THE INVENTION

The present invention relates to a fuel cell hybrid power supply apparatus, more particularly, a power supply apparatus that provides a filet cell device and uses a secondary battery and a secondary battery power supply circuit for power regulation to achieve stable output control of the fuel cell.

### BACKGROUND OF THE INVENTION

Because of the work characteristics of conventional fuel cell, when the fuel cell outputs power to a load, the power voltage/current characteristics would vary with the load demand. When the fuel cell is insufficient to meet the power demand of the load, the fuel cell will not be able to generate sufficient electrical potential, which might indirectly harm the operation of the fuel cell. Thus the present invention uses a hybrid power supply apparatus which contains secondary battery or other DC power supplier to ensure the power supply to the load.

Fuel cells typically use hydrogen-rich fuel and oxygen-containing fuel to undergo electrochemical reaction and directly supply electric power as in the case of direct methanol fuel cell (DMFC) and proton exchange membrane fuel cell (PEM). In the power output of the fuel cell, it is necessary to control the operating conditions of fuel cell, ex. temperature and fuel concentration, and accommodate the power demand of the load. Thus when load demand is unstable, the fuel cell operation control becomes more difficult. But conventional fuel cell technology so far has not discussed any apparatus or method for stable power supply control at the output end of the fuel cell.

In light of the drawbacks of conventional fuel cell output control, the inventor aims to develop a fuel cell hybrid power supply apparatus that dynamically control the power output of fuel cell by simple means.

### SUMMARY OF THE INVENTION

The primary object of the invention is to provide a fuel cell hybrid power supply apparatus, which comprises a secondary battery unit and a charger unit for charging the secondary battery unit to support the fuel cell apparatus in power supply to the load circuit, and at the same time, to regulate the power, voltage or current level during the charge of secondary battery such that the fuel cell apparatus is enable to output stable power level.

Another object of the invention is to provide a fuel cell hybrid power supply apparatus, which is a fuel cell power supply circuit having a sensor unit to detect power outputted by the fuel cell apparatus and provide such information as basis for corresponding control.

Yet another object of the invention is to provide a fuel cell hybrid power supply apparatus, where its fuel cell power supply circuit and secondary battery power supply circuit each has a voltage conversion unit to control the voltage outputted by the respective circuit.

To achieve the aforesaid objects, the present invention provides a fuel cell hybrid power supply apparatus, comprising a fuel cell power supply circuit including a fuel cell unit, a fuel cell voltage conversion unit and a sensor unit, the fuel cell unit being a fuel cell power generating device, the fuel cell voltage conversion unit being a power voltage conversion device, the sensor unit being for detecting the characteristics of power outputted by the fuel cell power supply circuit and outputting an electrical signal corresponding to the characteristics of power outputted by the fuel cell unit; and a secondary battery power supply circuit including a secondary battery and a charger unit, the secondary battery being a rechargeable energy storage device, the charger unit being a power control device and controlling the characteristics of power supplied by the secondary battery power supply circuit, to charge of the secondary battery; wherein the fuel cell power supply circuit and the secondary battery power supply circuit are electrically connected in parallel, the power input terminal of the secondary battery power supply circuit being electrically connected to the power output terminal of the fuel cell unit, the power output terminal of the secondary battery power supply circuit being electrically connected to the power output terminal of the fuel cell power supply circuit, the fuel cell and the fuel cell voltage conversion unit being electrically connected in series in the fuel cell power supply circuit, the sensor unit being electrically connected to the charger unit; the charger unit determines the power characteristics supplied by the secondary battery power supply circuit for charging the secondary battery, according to the electrical signal outputted by the sensor unit; the sensor unit regulates the predetermined voltage level at the output terminal of the fuel cell power supply circuit and the predetermined voltage level at the output terminal of the secondary battery power supply circuit with a differential between the two predetermined voltage levels based on the power transmitted by the fuel cell power supply circuit, and controls the charge of the secondary battery unit by the charger unit; and the fuel cell unit outputs power at a predetermined constant work rate.

The fuel cell hybrid power supply apparatus of the present invention comprises: a plurality of fuel cell power supply circuits, each fuel cell power supply circuit including a fuel cell unit and a fuel cell voltage conversion unit, the fuel cell unit being a fuel cell power generating device, and the fuel cell voltage conversion unit being a power voltage conversion device; a sensor unit, the sensor unit being for detecting the characteristics of power outputted by the fuel cell power supply circuit and outputting an electrical signal corresponding to the characteristics of power outputted by the fuel cell unit; and a secondary battery power supply circuit including a secondary battery and a charger unit the secondary battery being a rechargeable energy storage device, the charger unit being a power control device and controlling the characteristics of power supplied by the secondary battery power supply circuit for charging the secondary battery; wherein the fuel cell power supply circuit and the secondary battery power supply circuit are electrically connected in parallel, the fuel cell, the fuel cell voltage conversion unit and the sensor unit being electrically connected in series in the fuel cell power supply circuit, the sensor unit being electrically connected to the charger unit; the charger unit determines the power characteristics supplied by the secondary battery power supply circuit for charging the secondary battery based on the electrical signal outputted by the sensor unit; and the sensor unit regulates the voltage differential between the output terminal of the fuel cell power supply circuit and the output terminal of the secondary battery power supply circuit based on the power transmitted by the fuel cell power supply circuit, and controls the charge of the secondary battery unit by the charger unit.

The objects, features and effects of the invention are described in detail below with embodiments in reference to the accompanying drawings.

### BRIEF DESCRIPTION OF THE DRAWINGS

FIG. 1 is the component diagram of a fuel cell hybrid power supply apparatus according to a first embodiment of the invention;

FIG. 2 is a diagram showing the signal control of the fuel cell hybrid power supply apparatus according to the invention;

FIG. 3 is another diagram showing the signal control of the fuel cell hybrid power supply apparatus according to the invention;

FIG. 4 is the component diagram of a fuel cell hybrid power supply apparatus according to a second embodiment of the invention; and

FIG. 5 is the component diagram of a fuel cell hybrid power supply apparatus according to a third embodiment of the invention.

### DETAILED DESCRIPTION OF THE INVENTION

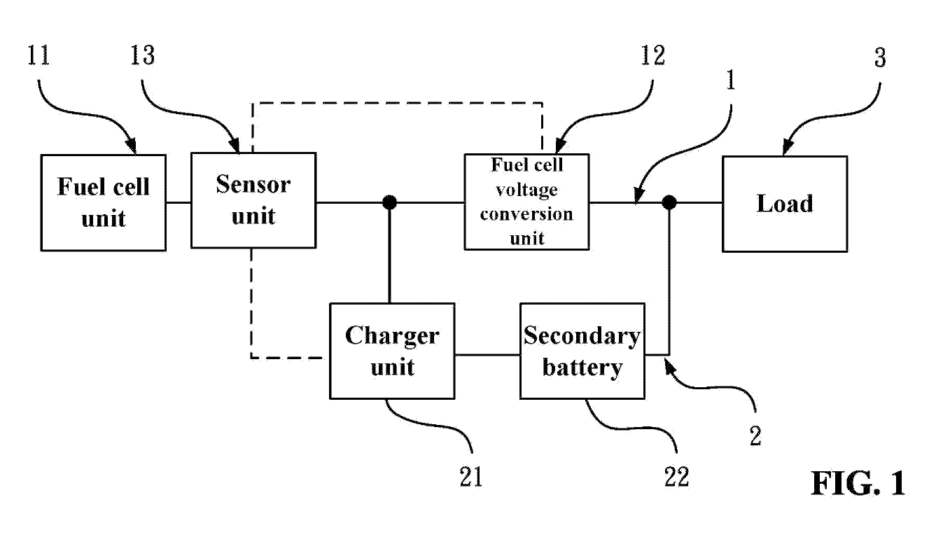

FIG. 1 is the component diagram of a fuel cell hybrid power supply apparatus according to a first embodiment of the invention. The fuel cell hybrid power supply apparatus comprises a fuel cell power supply circuit (1) and a secondary battery power supply circuit (2). The fuel cell unit (11) outputs stable electric power, and based on the power demand of a load (3), determines the output power of the secondary battery power supply circuit (2) or determines whether the fuel cell unit (11) should supply part of the power to the secondary battery power supply circuit (2) for charging.

In the fuel cell hybrid power supply apparatus, the fuel cell power supply circuit (1) consists of a fuel cell unit (11), a fuel cell voltage conversion unit (12), and a sensor unit (13). The fuel cell unit (11) is a power generating device that uses hydrogen-rich fuel and oxygen to undergo electrochemical reaction and generates power for output. The fuel cell voltage conversion unit (12) is a DC/DC voltage conversion device with one end electrically connected to the fuel cell unit (11) and could contain a DC voltage booster circuit or a DC voltage buck circuit to convert the DC power that is generated by the fuel cell unit (11) and inputted into the input terminal of the fuel cell voltage conversion unit (12) into DC power of specific voltage for output. The sensor unit (13) is a power detecting device electrically connected to the fuel cell power supply circuit (1) for detecting the characteristics of power transmitted by the fuel cell power supply circuit (1) and outputting an electrical signal corresponding to said power characteristics. For example, the power characteristics could be the current level, voltage level or power level at a local loop of the fuel cell power supply circuit (1). In addition, the characteristics of power outputted by the fuel cell unit (11) corresponding to the power characteristics of the local loop of the fuel cell power supply circuit (1) may be obtained based on the characteristics of the fuel cell power supply circuit (1); the corresponding relationship of the two may be obtained by experiment, theoretical calculation, or numerical method.

In the fuel cell hybrid power supply apparatus, the secondary battery power supply circuit (2) consists of a charger unit (21) and a secondary battery unit (22). The secondary battery unit (22) is a rechargeable energy storage device. The charger unit (21) is a power control device for controlling the electric power or current or voltage level when charging the secondary battery unit (22). The power input terminal of the charger unit (21) is electrically connected to the fuel cell power supply circuit (1), whereas its power output terminal is electrically connected to the secondary battery unit (22). The power output terminal of the secondary battery unit (22) is electrically connected to the power output terminal of the fuel cell power supply circuit (1).

In the fuel cell power supply circuit (1), the power output terminal of the fuel cell unit (11) is electrically connected to the secondary battery power supply circuit (2). The power output terminal of the fuel cell power supply circuit (1) is electrically connected to the power output terminal of the secondary battery power supply circuit (2) such that the fuel cell unit (11) could output power via the fuel cell power supply circuit (1) to the secondary battery power supply circuit (2) or the load (3). The fuel cell unit (11) in the fuel cell power supply circuit (1) and the secondary battery unit (22) in the secondary battery power supply circuit (2) could form a hybrid power supply to supply the load (3).

As such, the DC power outputted by the fuel cell unit (11) could be transmitted to the fuel cell voltage conversion unit (12) via the fuel cell power supply circuit (1) to undergo the voltage conversion of DC power and output DC power of specific voltage, which is then transmitted to the load (3) to supply DC power needed by the load (3). Moreover, the sensor unit (13) could detect the current, voltage or power state of the fuel cell power supply circuit (1) and feed the detected result to the fuel cell voltage conversion unit (12) in the form of a corresponding signal so as to control the operation of the fuel cell voltage conversion unit (12).

In the electrical parallel connection of the fuel cell power supply circuit (1) and the secondary; battery power supply circuit (2), the power output terminal of the secondary battery unit (22) in the secondary battery power supply circuit (2) could be electrically connected to a diode in series (not shown in the figure) to prevent the entry of reverse current from the power output terminal of the fuel cell power supply circuit (1) into the power output terminal of the secondary battery unit (22) in the secondary battery power supply circuit (2). However, if the power output terminal of the secondary battery unit (22) is equipped with a DC/DC voltage converter, the installation of the diode is not necessary. The reverse current prevention technique is a general technology of the power system. The reverse current prevention means mentioned in the invention is just cited as an example and does not mean to limit the means to achieve the objective of reverse current prevention.

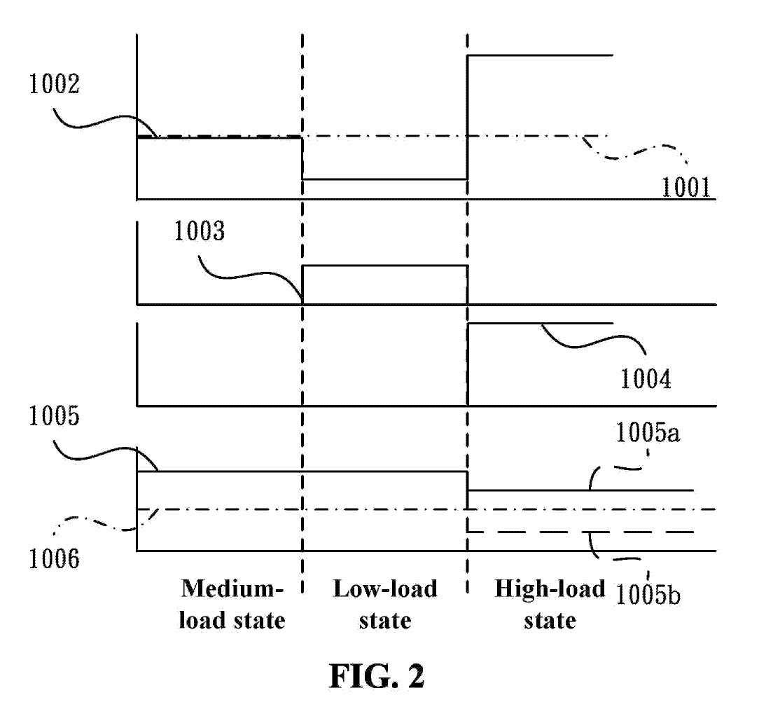

Referring to FIG. 1 and FIG. 2, which a diagram showing the signal control of the fuel cell hybrid power supply apparatus according to the invention, in the fuel cell hybrid power supply apparatus, the power generated by the fuel cell unit (11) in the fuel cell power supply circuit (1) is a fuel cell unit output power (1001), which is converted by the fuel cell voltage conversion unit (12) for output, and the output voltage is a fuel cell power supply circuit predetermined output voltage (1005). The power consumed by the load (3) is a load power loss (1002). The power supplied by the fuel cell unit (11) and received by the charger unit (21) is a charger unit power (1003). The power generated and outputted by the secondary battery unit (22) in the secondary battery power supply circuit (2) is a secondary battery power supply circuit output power (1004), and the output voltage is a secondary battery power supply circuit output voltage (1006).

The fuel cell unit output power (1001) mainly corresponds to the output power of the fuel cell unit (11), which in reality must consider the power loss in the fuel cell power supply circuit (1). For example, when the fuel cell voltage conversion unit (12) undergoes power conversion, power loss occurs. As such, the power loss from the working of the fuel cell voltage conversion unit (12) must be deducted from the fuel cell unit output power (1001) to obtain power outputted by the fuel cell power supply circuit (1). However such power loss could be estimated and compensation for the fuel cell unit output power (1001) may be determined with the design of the sensor unit (13).

In the signal control diagram of FIG. 2, when the fuel cell unit output power (1001) is equal to the load power loss (1002), it is defined as a medium-load state; when the fuel cell unit output power (1001) is greater than the load power loss (1002), it is defined as a low-load state; when the fuel cell unit output power (1001) is smaller than the load power loss (1002), it is defined as a high-load state. In the medium-load state, the fuel cell power supply circuit predetermined output voltage (1005) is slightly higher than the secondary battery power supply circuit output voltage (1006), and the charger unit power (1003) outputted by the fuel cell unit (11) to the charger unit (21) is zero, the secondary battery power supply circuit output power (1004) outputted by the secondary battery power supply circuit (2) is also zero, and the fuel cell unit output power (1001) covers exactly the load power loss (1002) such that the charger unit (21) will not charge the secondary battery unit (22) and the secondary battery unit (22) does not output power to the load (3). In the low-load state, the fuel cell power supply circuit predetermined output voltage (1005) is slightly higher than the secondary battery power supply circuit output voltage (1006), and the secondary batten, power supply circuit output power (1004) outputted by the secondary battery power supply circuit (2) is zero, while the charger unit power (1003) outputted by the fuel cell unit (11) to the charger unit (21) is not zero, and the output power of the fuel cell unit (11) is kept the same as that in medium-load state such that the power outputted by the fuel cell unit (11) is supplied for the load power loss (1002) of the load (3), and the excess power from the fuel cell unit (11) is supplied to the charger unit (21) for charging the secondary battery unit (22), whereas the secondary battery unit (22) will not output power to the load (3). In the high-load state, the sensor unit (13) would regulate the voltage conversion of the fuel cell voltage conversion unit (12) based on the power state of the fuel cell power supply circuit (1) so that there is a differential between fuel cell power supply circuit predetermined output voltage (1005) and secondary battery power supply circuit output voltage (1006). In addition, the sensor unit (13) enables the fuel cell unit (11) in the fuel cell power supply circuit (1) and the secondary battery unit (22) in the secondary battery power supply circuit (2) to output power synergistically to the load (3), and enable the fuel cell unit (11) to maintain the same output power as that in the medium-load state. Without taking into account the transmission loss of the fuel cell power supply circuit (1), the sum of fuel cell unit output power (1001) and secondary battery power supply circuit output power (1004) would be equal to the load power loss (1002) of the load (3). Thus the fuel cell hybrid power supply apparatus could stabilize the power outputted by the fuel cell unit (11) of the fuel cell power supply circuit (1), and through voltage control of the fuel cell voltage conversion unit (12) and coordination with power output of the secondary battery unit (22) in the secondary battery power supply circuit (2), maintain stable and constant power outputted by the fuel cell unit (11), while meeting the power demand of the load (3).

More specifically, if the output distribution ratio under steady-state output in high-load state is such that the fuel cell unit output power (1001) is higher than the secondary battery power supply circuit output power (1004), the fuel cell unit output power (1001) adopts a first predetermined voltage level (1005a) in the high-load state, and the first predetermined voltage level (1005a) is slightly higher than the secondary battery power supply circuit output voltage (1006). In addition, in the output distribution ratio under steady-state output in high-load state is such that the fuel cell unit output power (1001) is lower than the secondary battery power supply circuit output power (1004), the fuel cell unit output power (1001) adopts a second predetermined voltage level (1005b) in the high-load state, and the second predetermined voltage level (1005b) is slightly lower than the secondary battery power supply circuit output voltage (1006). In the aforesaid high-load state, the differential between the first predetermined voltage level (1005a) of the fuel cell power supply circuit predetermined output voltage (1005) and the secondary battery power supply circuit output voltage (1006), or the differential between the second predetermined voltage level (1005b) of the fuel cell power supply circuit predetermined output voltage (1005) and the secondary battery power supply circuit output voltage (1006) would determine the ratio of the fuel cell unit output power (1001) and secondary battery power supply circuit output power (1004).

The sensor unit (13) is used to detect the voltage, current or rate of work of DC power outputted by the fuel cell unit (11), and the electrical signal fed by the sensor unit (13) is used to control the DC/DC power conversion ratio of the fuel cell voltage conversion unit (12), thereby maintaining the power output of the fuel cell unit (11).

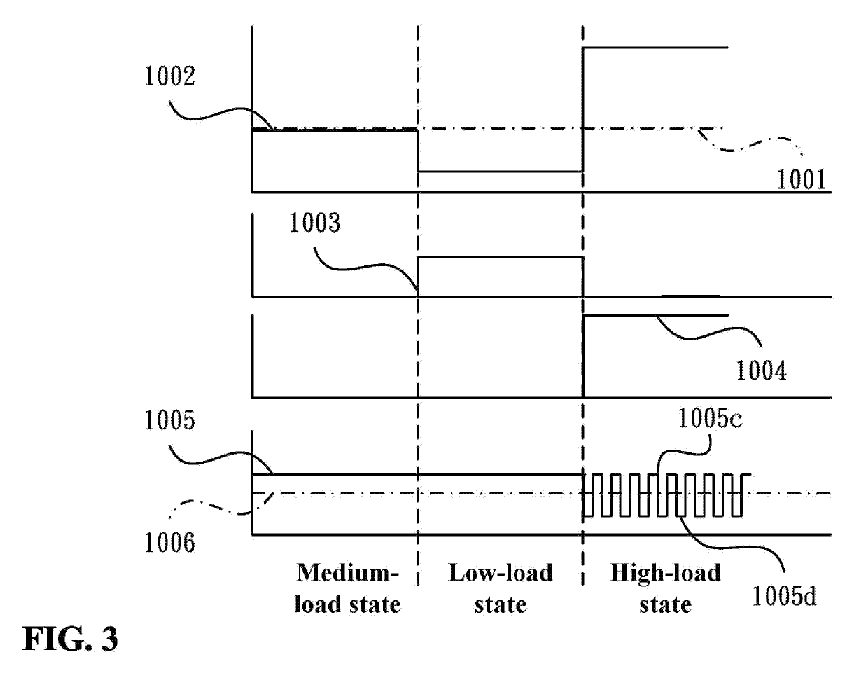

FIG. 3 shows another signal control diagram of the fuel cell hybrid power supply apparatus according to the invention. In the high-load state as described in the aforesaid example, the fuel cell hybrid power supply apparatus feeds a signal corresponding to the result detected by the sensor unit (13) to the fuel cell voltage conversion unit (12) to keep the fuel cell unit (11) of the fuel cell power supply circuit (1) in a voltage signal pattern oscillating between a third predetermined voltage level (1005c) with higher potential and a fourth predetermined voltage level (1005d) with lower potential, wherein through controlling the differential between the fuel cell power supply circuit predetermined output voltage (1005) and the secondary battery power supply circuit output voltage (1006), the fuel cell hybrid power supply apparatus could control the output distribution ratio between the fuel cell unit output power (1001) and the secondary battery power supply circuit output power (1004). Without taking into account the transmission loss of the fuel cell power supply circuit (1), the sum of fuel cell unit output power (1001) and secondary battery power supply circuit output power (1004) could reach the load power loss (1002) of the load (3). In addition, by controlling the duty cycle formed by oscillation between the third predetermined voltage level (1005c) and the fourth predetermined voltage level (1005d) of the fuel cell power supply circuit predetermined output voltage (1005) in high-load state, the output distribution ratio between the fuel cell unit output power (1001) and the secondary battery power supply circuit output power (1004) could be controlled. Without taking into account the transmission loss of the fuel cell power supply circuit (1), the sum of fuel cell unit output power (1001) and secondary battery power supply circuit output power (1004) could reach the load power loss (1002) of the load (3).

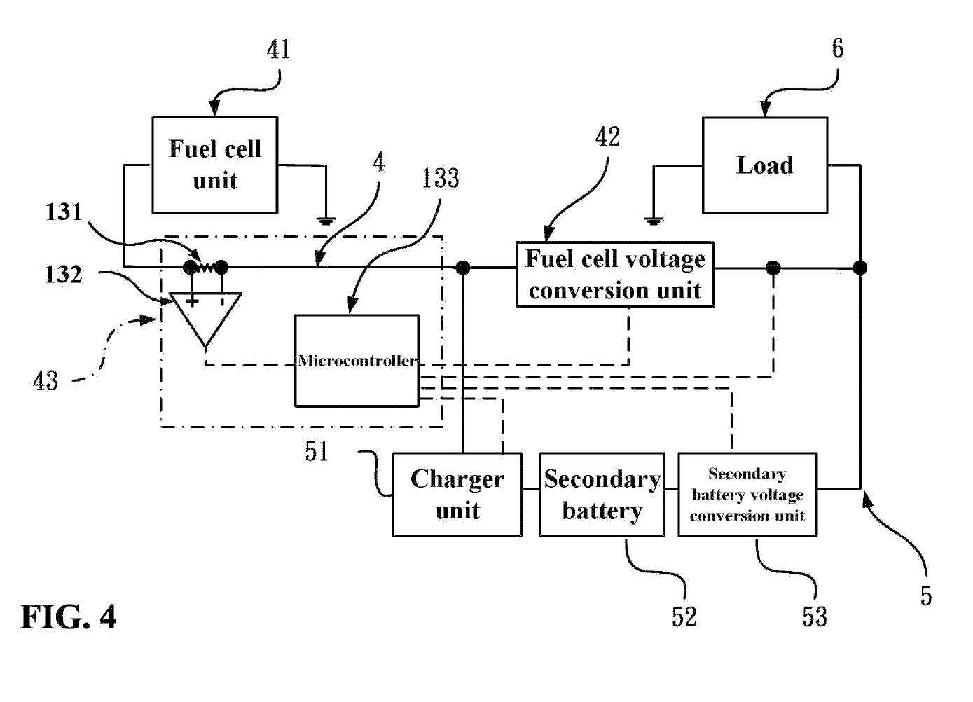

FIG. 4 is the component diagram of a fuel cell hybrid power supply apparatus according to a second embodiment of the invention. In this embodiment, the secondary battery power supply circuit (5) further consists of a secondary battery voltage conversion unit (53). The secondary battery voltage conversion unit (53) is a DC power circuit with energy storage and release mechanism and electrically connected in series to the rear end of the secondary battery unit (52) in the secondary battery power supply circuit (5) so that the power outputted by the secondary battery unit (52) could be converted into stable voltage, which could be outputted in parallel connection with the power outputted by the fuel cell power supply circuit (4) to the load (6) to supply the power needed by the load (6). The secondary battery voltage conversion unit (53) is equipped with a general current limiting mechanism, which, through reasonable control signal, could control the current level inputted into the secondary battery voltage conversion unit (53) or outputted by the secondary battery voltage conversion unit (53) to a level not exceeding a rated current level and regulate the output voltage converted by the secondary battery voltage conversion unit (53). In the aforesaid control means by regulating the output voltage of the fuel cell power supply circuit (4) and the secondary battery power supply circuit (5), the same objective could be achieved by regulating the output voltage after the secondary battery voltage conversion unit (53) in the secondary battery power supply circuit (5) has converted the power outputted by the secondary battery unit (52), or regulating simultaneously the predetermined voltage level of the fuel cell voltage conversion unit (42) in the fuel cell power supply circuit (4) and the predetermined voltage level of the secondary battery voltage conversion unit (53) in the secondary battery power supply circuit (5). That is, the fuel cell power supply circuit predetermined output voltage (1005) and the secondary battery power supply circuit output voltage (1006) shown in FIG. 2 and FIG. 3 has a corresponding relationship. Specifically, the hybrid power outputted by the fuel cell unit (41) in the fuel cell power supply circuit (4) and by the secondary cell unit (52) in the secondary battery power supply circuit (5) is achieved by controlling the regulation of differential between the fuel cell power supply circuit predetermined output voltage (1005) and the secondary battery power supply circuit output voltage (1006), or the variation of the differential.

Moreover, in the aforesaid embodiment, the sensor unit (43) in the fuel cell power supply circuit (4) further consists of a sensor element (431) and a microcontroller (433). The sensor element (431) is electrically connected to the fuel cell power supply circuit (4) to output an electrical signal corresponding to the power transmitted in the fuel cell power supply circuit (4) to the microcontroller (433). The microcontroller (433) could output a voltage signal corresponding to the inputted electrical signal and is electrically connected to the sensor element (431), the fuel cell voltage conversion unit (42), and the secondary battery voltage conversion unit (53). The microcontroller (433) generates a corresponding voltage signal based on the power characteristics signal provided by the sensor element (431) and feeds the voltage signal to the fuel cell voltage conversion unit (42) or the secondary battery voltage conversion unit (53) so as to set the output voltage level after voltage conversion by the fuel cell voltage conversion unit (42) or the secondary battery voltage conversion unit (53). As such, control over the distribution of power outputted by the fuel cell power supply circuit (4) and the secondary battery power supply circuit (5) is achieved.

The sensor element (431) in the sensor unit (43) can be composed of one or a plurality of elements selected from circuit made of differential amplifier, Hall element and sensor chip. The sensor element (431) could output a corresponding electrical signal based on the current vale voltage value or electric power value transmitted by the fuel cell power supply circuit (4), and the electrical signal allows the microcontroller (433) to carry out logic computing for the control process. Or the sensor unit (43) could work without the microcontroller (433) and use the electrical signal from the sensor element (431) directly to control the distribution of power outputted by the fuel cell power supply circuit (4) and the secondary battery power supply circuit (5).

The sensor unit (43) could be disposed on the fuel cell power supply circuit (4) and situated between the electrical junction of the power output of the fuel cell power supply circuit (4) and the secondary battery power supply circuit (5) and the load (6) to detect the amount of power supply contributed by the fuel cell unit (41) of the fuel cell power supply circuit (4) or other electrical characteristics.

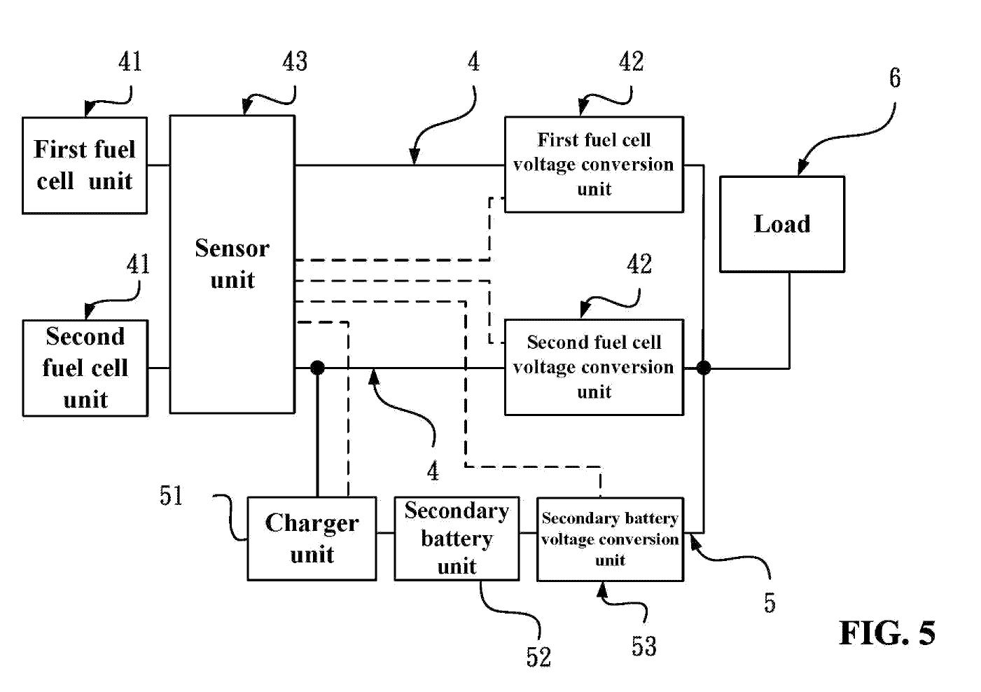

FIG. 5 is the component diagram of a fuel cell hybrid power supply apparatus according to a third embodiment of the invention. In this embodiment, the fuel cell hybrid power supply apparatus comprises a plurality of fuel cell power supply circuits (4) and a secondary battery power supply circuit (5). The fuel cell power supply circuits (4) respectively output stable electric power, and based on the load (6) demand, determines power outputted by the secondary battery power supply circuit (5) or determines the supply of part of the power from respective fuel cell power supply circuits (4) to the secondary battery power supply circuit (5) for charging.

In the aforesaid fuel cell hybrid power supply apparatus, each fuel cell power supply circuit (4) comprises a fuel cell unit (41) and a fuel cell voltage conversion unit (42). The sensor unit (43) detects the power transmitted by respective fuel cell power supply circuit (4). The fuel cell unit (41) is a power generating device that uses hydrogen-rich fuel and oxygen to undergo electrochemical reaction and generates power for output. The fuel cell voltage conversion unit (42) is a DC/DC voltage conversion device with one end electrically connected to the fuel cell unit (41) and could contain a DC voltage booster circuit or a DC voltage buck circuit to convert the DC power that is generated by the fuel cell unit (41) and inputted into the input terminal of the fuel cell voltage conversion unit (42) into DC power of specific voltage for output. The sensor unit (43) is electrically connected to the respective fuel cell power supply circuit (4) for detecting the characteristics of power transmitted by the fuel cell power supply circuit (4) and outputting an electrical signal corresponding to said power characteristics. For example, the power characteristics could be the current level, voltage level or power level at a local loop of the fuel cell power supply circuit (4).

In the aforesaid fuel cell hybrid power supply apparatus, the secondary battery power supply circuit (5) consists of a charger unit (51) and a secondary battery unit (52). The secondary battery unit (52) is a rechargeable energy storage device. The charger unit (51) is a power control device for controlling the electric power or current or voltage level when charging the secondary battery unit (52). The power input terminal of the charger unit (51) is electrically connected to the fuel cell power supply circuit (4), whereas its power output terminal is electrically connected to the secondary battery unit (52). The power output terminal of the secondary battery unit (52) is electrically connected to the secondary battery voltage conversion unit (43), while the power output terminal of the secondary battery voltage conversion unit (53) and the power output terminal of the fuel cell power supply circuit (4) are electrically connected in parallel.

In the aforesaid fuel cell power supply circuit (4), the power output terminal of the fuel cell unit (41) in at least one of the fuel cell power supply circuit (4) is electrically connected to the secondary battery power supply circuit (5). The power output terminal of the fuel cell power supply circuits (4) are electrically connected in parallel to the power output terminal of the secondary battery power supply circuit (5) such that respective fuel cell unit (41) could output power from the corresponding fuel cell power supply circuit (4) to the secondary battery power supply circuit (5) or the load (6), and the fuel cell units (41) in the fuel cell power supply circuits (4) and the secondary battery unit (52) in the secondary battery power supply circuit (5) can form hybrid power to supply the load (6).

The secondary battery power supply circuit (5) further consists of a secondary battery voltage conversion unit (53). The secondary battery voltage conversion unit (53) is a DC power circuit with energy storage and release mechanism and electrically connected in series to the rear end of the secondary battery unit (52) in the secondary battery power supply circuit (5) so that the power outputted by the secondary battery unit (52) could be converted into stable output voltage, which could be outputted in parallel connection with the power outputted by the fuel cell unit (41) in the fuel cell power supply circuit (4) to the load (6) to meet load demand. The secondary battery voltage conversion unit (53) is equipped with a general current limiting mechanism, which, through reasonable control signal, could control the current level inputted into the secondary batten voltage conversion unit (53) or outputted by the secondary battery voltage conversion unit (53) to a level not exceeding a rated current level and regulate the output voltage converted by the secondary battery voltage conversion unit (53).

The DC power outputted by respective fuel cell units (41) could be transmitted to the fuel cell voltage conversion unit (42) through the corresponding fuel cell power supply circuit (4) for DC voltage conversion and outputting DC power of specific voltage to the load (6) to meet the load demand. Moreover, the sensor unit (43) could detect the current, voltage or electric power state of each fuel cell power supply circuit (4) and feed a corresponding electrical signal based oil the detected result to the fuel cell voltage conversion unit (42) so as to control the operation of the fuel cell voltage conversion unit (42).

In this embodiment, the sensor unit (43) could, through the voltage differential regulation method discussed in the aforesaid embodiment, regulate the fuel cell voltage conversion unit (42) or the output voltage after the secondary battery voltage conversion unit (53) in the secondary battery power supply circuit (5) has converted the power outputted by the secondary battery unit (52), or regulating simultaneously the fuel cell voltage conversion unit (42) in the fuel cell power supply circuit (4) and the secondary battery voltage conversion unit (53) in the secondary battery power supply circuit (5).

The examples cited above are meant to explain the invention and should not be construed as a limitation on the actual applicable scope of the invention, and as such, all modifications and alterations without departing from the spirits of the invention and appended claims shall remain within the protected scope and claims of the invention.

What is claimed is:

1. A fuel cell hybrid power supply apparatus, comprising:
a fuel cell power supply circuit including a fuel cell unit, a fuel cell voltage conversion unit and a sensor unit, the fuel cell unit being a fuel cell power generating device, the fuel cell voltage conversion unit being a power voltage conversion device, the sensor unit being for detecting the characteristics of the power outputted by the fuel cell power supply circuit, and for outputting an electrical signal corresponding to the characteristics of power outputted by the fuel cell unit; and
a secondary battery power supply circuit including a secondary battery and a charger unit, the secondary battery being a rechargeable energy storage device, the charger unit being a power control device and controlling the characteristics of power supplied by the secondary battery power supply circuit for charging the secondary battery;
wherein the fuel cell power supply circuit and the secondary battery power supply circuit are electrically connected in parallel; the input terminal of the secondary battery power supply circuit is electrically connected to the power output terminal of the fuel cell unit and the output terminal of the secondary battery power supply circuit is electrically connected to the output terminal of the fuel cell power supply circuit; the fuel cell and the fuel cell voltage conversion unit is electrically connected in series in the fuel cell power supply circuit and the sensor unit is electrically connected to the charger unit; the charger unit determines the power characteristics supplied by the secondary battery power supply circuit for charging the secondary battery, according to the electrical signal outputted by the sensor unit; the sensor unit regulates the predetermined voltage level at the output terminal of the fuel cell power supply circuit and the predetermined voltage level at the output terminal of the secondary battery power supply circuit with a differential between the two predetermined voltage levels, according to the power transmitted by the fuel cell power supply circuit, and controls the charger unit to charge the secondary battery unit; and the fuel cell unit outputs power at a predetermined constant work rate.

2. The fuel cell hybrid power supply apparatus according to claim 1, wherein in the state of the power outputted by the fuel cell power supply circuit being lower than the power outputted by the fuel cell unit, the sensor unit regulates the predetermined voltage level at the output terminal of the fuel cell power supply circuit and the predetermined voltage level at the output terminal of the secondary battery power supply circuit such that the fuel cell power supply circuit would output power while the output terminal of the secondary battery power supply circuit would stop the power output, and the sensor unit selects the charger unit of the secondary battery power supply circuit to charge the secondary battery, the sensor unit regulating the power of charger unit in the charging process such that the fuel cell unit outputs power at a predetermined constant work rate.

3. The fuel cell hybrid power supply apparatus according to claim 2, wherein the sensor unit controls the predetermined voltage level outputted by the fuel cell power supply circuit to be higher than the predetermined voltage level outputted by the secondary battery power supply circuit to stop the power outputted by the secondary battery power supply circuit.

4. The fuel cell hybrid power supply apparatus according to claim 3, wherein the sensor unit regulates the differential between the output voltage of the fuel cell voltage conversion unit and the output voltage of the secondary battery power supply circuit.

5. The fuel cell hybrid power supply apparatus according to claim 4, wherein the output terminal of the secondary battery power supply circuit further comprises a secondary battery voltage conversion unit, the secondary battery voltage conversion unit being a voltage conversion device; and the sensor unit regulates the differential between the output voltage of the fuel cell voltage conversion unit and the output voltage of the secondary battery voltage conversion unit.

6. The fuel cell hybrid power supply apparatus according to claim 4, wherein the output terminal of secondary battery power supply circuit further comprises a secondary battery voltage conversion unit, the secondary battery voltage conversion unit being a voltage conversion device; and the sensor unit regulates the voltage signal of specific duty cycle formed by the differential between the predetermined voltage outputted by the fuel cell voltage conversion unit and the predetermined voltage outputted by the secondary battery voltage conversion unit, to control the output distribution ratio between the fuel cell power supply circuit and the secondary battery power supply circuit.

7. The fuel cell hybrid power supply apparatus according to claim 1, wherein in the state of the power outputted by the fuel cell power supply circuit being higher than the power outputted by the fuel cell unit, the sensor unit regulates the predetermined voltage level at the output terminal of the fuel cell power supply circuit and the predetermined voltage level at the output terminal of the secondary battery power supply circuit, and the sensor unit selects the charger unit of the secondary battery power supply circuit to stop charging the secondary battery such that the output terminals of both the fuel cell power supply circuit and the secondary battery power supply circuit would output power and the fuel cell unit outputs power at a predetermined constant work rate.

8. The fuel cell hybrid power supply apparatus according to claim 7, wherein the sensor unit controls the predetermined voltage level outputted by the fuel cell power supply circuit being slightly higher than the predetermined voltage level outputted by the secondary battery power supply circuit such that the fuel cell unit outputs power at a predetermined constant work rate, and the output power at the output terminal of secondary battery power supply circuit is lower than the output power of the fuel cell unit; and the sensor unit controls the predetermined voltage level outputted by the fuel cell power supply circuit being slightly lower than the predetermined voltage level outputted by the secondary battery power supply circuit such that the fuel cell unit outputs power at a predetermined constant work rate, and the output power at the output terminal of secondary battery power supply circuit is higher than the output power of the fuel cell unit.

9. The fuel cell hybrid power supply apparatus according to claim 8, wherein the sensor unit regulates the differential between the output voltage of the fuel cell voltage conversion unit and the output voltage of the secondary battery power supply circuit.

10. The fuel cell hybrid power supply apparatus according to claim 9, wherein the power output terminal of the secondary battery power supply circuit further comprises a secondary battery voltage conversion unit, the secondary battery voltage conversion unit being a voltage conversion unit; and the sensor unit regulates the differential between the output voltage of the fuel cell voltage conversion unit and the output voltage of the secondary battery voltage conversion unit.

11. The fuel cell hybrid power supply apparatus according to claim 7, wherein the sensor unit regulates the voltage signal of specific duty cycle formed by the differential between the predetermined voltage outputted by the fuel cell power supply circuit and the predetermined voltage outputted by the secondary battery power supply circuit, to control the output distribution ratio between the fuel cell power supply circuit and the secondary battery power supply circuit.

12. The fuel cell hybrid power supply apparatus according to claim 11, wherein the sensor unit regulates the voltage signal of specific duty cycle formed by the predetermined voltage at the output terminal of the fuel cell voltage conversion unit such that the voltage signal of specific duty cycle formed by the differential between the predetermined voltage outputted by the fuel cell power supply circuit and the predetermined voltage outputted by the secondary battery power supply circuit can be regulated to control the output distribution ratio between the fuel cell power supply circuit and the secondary batter power supply circuit.

13. The fuel cell hybrid power supply apparatus according to claim 12, wherein the power output terminal of the secondary battery power supply circuit further consists of a secondary battery voltage conversion unit, the secondary battery voltage conversion unit being a voltage conversion device, and the sensor unit regulates voltage signal of specific duty cycle formed by the differential between the predetermined voltage outputted by the fuel cell voltage conversion unit and the predetermined voltage outputted by the secondary battery voltage conversion unit to control the output distribution ratio between the fuel cell power supply circuit and the secondary battery power supply circuit.

14. The fuel cell hybrid power supply apparatus according to claim 1, wherein in the state of the power outputted by the fuel cell power supply circuit being equal to the power outputted by the fuel cell unit, the sensor unit regulates the predetermined voltage level at the output terminal of the fuel cell power supply circuit and the predetermined voltage level at the output terminal of the secondary battery power supply circuit and the sensor unit selects the charger unit of the secondary battery power supply circuit to stop charging the secondary battery such that the fuel cell power supply circuit would output power while the output terminal of the secondary battery power supply circuit would stop the power output, and the fuel cell unit outputs power at a predetermined constant work rate.

15. The fuel cell hybrid power supply apparatus according to claim 1, wherein the fuel cell voltage conversion unit includes at least a DC voltage booster circuit and at least a DC voltage buck circuit.

16. The fuel cell hybrid power supply apparatus according to claim 1, wherein the sensor unit further comprises a sensor element and a microcontroller, the sensor element being electrically connected to the fuel cell power supply circuit and outputting an electrical signal corresponding to the power transmitted in the fuel cell power supply circuit to the microcontroller, through the microcontroller, the sensor unit regulating the voltage differential between the output terminal of the fuel cell power supply circuit and the output terminal of the secondary battery power supply circuit and controlling the charger unit in carrying out to charge the secondary battery unit.

17. The fuel cell hybrid power supply apparatus according to claim 1, wherein the sensor unit is disposed at any position between the high potential location and the low potential location of the fuel cell power supply circuit.

18. The fuel cell hybrid power supply apparatus according to claim 1, wherein the sensor unit comprises a sensor element, the sensor element being selected from a circuit consisting of the differential amplifier, a Hall element or a sensor chip, and the sensor element outputting a electrical signal corresponding to the current value, voltage value or electric power value outputted by the fuel cell power supply circuit.

19. A fuel cell hybrid power supply apparatus, comprising:
a plurality of fuel cell power supply circuits, each fuel cell power supply circuit comprising a fuel cell unit and a fuel cell voltage conversion unit, the fuel cell unit being a fuel cell power generating device, the fuel cell voltage conversion unit being a power voltage conversion device;
a sensor unit for detecting the characteristics of power outputted by the fuel cell power supply circuit and outputting an electrical signal corresponding to the characteristics of power outputted by the fuel cell power supply circuit; and
a secondary battery power supply circuit comprising a secondary battery and a charger unit, the secondary battery being a rechargeable energy storage device, the charger unit being a power control device and controlling the characteristics of power supplied by the secondary battery power supply circuit for charging the secondary battery;
wherein the fuel cell power supply circuits and the secondary battery power supply circuit are electrically connected in parallel, the power input terminal of the secondary battery power supply circuit being electrically connected to the power output terminal of the fuel cell units, the power output terminal of the secondary battery power supply circuit being electrically connected to the power output terminal of the fuel cell power supply circuits, the fuel cells and the fuel cell voltage conversion units being electrically connected in series in the corresponding fuel cell power supply circuit, the sensor unit being electrically connected to the charger unit; the charger unit determines the power characteristics supplied by the secondary battery power supply circuit for charging the secondary battery, according to the electrical signal outputted by the sensor unit; the sensor unit regulates the predetermined voltage level at the output terminal of the fuel cell power supply circuit and the predetermined voltage level at the output terminal of the secondary battery power supply circuit with a differential between the two predetermined voltage levels based on the power transmitted by the fuel cell power supply circuit, and the sensor unit controls the charge of the secondary battery unit by the charger unit; and the fuel cell units output power at a predetermined constant work rate.

20. The fuel cell hybrid power supply apparatus according to claim 19, wherein in the state of the power transmitted by any of the fuel cell power supply circuits being lower than the power outputted by the fuel cell unit, the sensor unit regulates the predetermined voltage level at the output terminal of the corresponding fuel cell power supply circuit and the predetermined voltage level at the output terminal of the secondary battery power supply circuit such that the corresponding fuel cell power supply circuit would output power while the output terminal of the secondary battery power supply circuit would stop the power output, and the sensor unit selects the charger unit of the secondary battery power supply circuit to charge the secondary battery, the sensor unit regulating the power of charger unit in the charging process such that the corresponding fuel cell unit outputs power at a predetermined constant work rate.

21. The fuel cell hybrid power supply apparatus according to claim 19, wherein in the state of the power transmitted by any of the fuel cell power supply circuits being higher than the power outputted by the fuel cell unit the sensor unit regulates the predetermined voltage level at the output terminal of the corresponding fuel cell power supply circuit and the predetermined voltage level at the output terminal of the secondary battery power supply circuit, and the sensor unit selects the charger unit of the secondary battery power supply circuit to stop charging the secondary battery such that the output terminals of both the corresponding fuel cell power supply circuit and the secondary battery power supply circuit would output power and the corresponding fuel cell unit outputs power at a predetermined constant work rate.

22. The fuel cell hybrid power supply apparatus according to claim 19, wherein in the state of the power transmitted by any of the fuel cell power supply circuits being equal to the power outputted by the fuel cell unit the sensor unit regulates the predetermined voltage level at the output terminal of the corresponding fuel cell power supply circuit and the predetermined voltage level at the output terminal of the secondary battery power supply circuits and the sensor unit selects the charger unit of the secondary battery power supply circuit to stop charging the secondary battery such that the corresponding fuel cell power supply circuit would output power while the output terminal of the secondary battery power supply circuit would stop the power output and the corresponding fuel cell unit outputs power at a predetermined constant work rate.

23. The filet cell hybrid power supply apparatus according to claim 19, wherein the fuel cell voltage conversion unit includes at least a DC voltage booster circuit and at least a DC voltage buck circuit.

24. The fuel cell hybrid power supply apparatus according to claim 19, wherein the sensor unit further comprises a plurality of sensor elements and a microcontroller, the sensor elements being respectively electrically connected to the corresponding fuel cell power supply circuit and outputting an electrical signal corresponding to the power transmitted in the fuel cell power supply circuit to the microcontroller, through the microcontroller, the sensor unit regulating the voltage differential between the predetermined voltage at output terminal of the fuel cell power supply circuit and the predetermined voltage at output terminal of the secondary battery power supply circuit and controlling the charger unit in carrying out to charge the secondary battery unit.

25. The fuel cell hybrid power supply apparatus according to claim 19, wherein the sensor units are disposed at any position between the high potential location and the low potential location of the fuel cell power supply circuits.

26. The fuel cell hybrid power supply apparatus according to claim 19, wherein the sensor unit further comprises a sensor element and a microcontroller, the sensor element being electrically connected to the corresponding fuel cell power supply circuit and outputting an electrical signal corresponding to the power transmitted in the fuel cell power supply circuit to the microcontroller, through the microcontroller, the sensor unit regulating the voltage differential between the output terminal of the corresponding fuel cell power supply circuit and the output terminal of the secondary battery power supply circuit and controlling the charger unit in carrying out to charge the secondary battery unit.

27. The fuel cell hybrid power supply apparatus according to claim 19, wherein each sensor unit comprises a sensor element, the sensor element being selected from a circuit consisting of the differential amplifier, a Hall element or a sensor chip, and the sensor element outputting a electrical signal corresponding to the current value, voltage value or electric power value outputted by the fuel cell power supply circuit.
